(19) United States
(12) Patent Application Publication
(10) Pub. No.: US 2026/0286971 A1
(43) Pub. Date: Sep. 24, 2026

(54) COMPRESSOR WHEEL AND CENTRIFUGAL COMPRESSOR

(71) Applicant: MITSUBISHI HEAVY INDUSTRIES ENGINE & TURBOCHARGER, LTD., Sagamihara-shi, Kanagawa (JP)

(72) Inventor: Takuya EHANA, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 18/873,803

(22) PCT Filed: Sep. 8, 2022
(86) PCT No.: PCT/JP2022/033760

§ 371 Date: Dec. 11, 2024

(51) Int. Cl. F04D 29/28; F04D 17/10

(52) U.S. Cl. CPC F04D 29/284; F04D 17/10; F05D 2250/71

(57) ABSTRACT

Provided is a compressor wheel comprising a hub and at least one blade provided on an outer surface of the hub. A back surface of the compressor wheel includes a flat part that extends along a radial direction of the compressor wheel and is positioned closer to a rear end side in an axial direction of the compressor wheel than an outer peripheral end of the back surface, and an outside surface that connects the flat part and the outer peripheral end of the back surface. The outside surface has an axial recessed part recessed toward a front end side in the axial direction than the outer peripheral end of the back surface.

### TECHNICAL FIELD

The present disclosure relates to a compressor wheel and a centrifugal compressor including the compressor wheel.

### BACKGROUND ART

In the related art, as a technique for improving the output of an engine (internal combustion engine) such as an automobile engine, a turbocharger (supercharger) that compresses intake air sucked by the engine to increase the density and supplies the intake air containing a large amount of oxygen to the engine is widely used.

The turbocharger includes, for example, a centrifugal compressor provided on one end side of the rotary shaft, and a turbine provided on the other end side of the rotary shaft. The turbocharger is configured to rotate a turbine rotor by energy of exhaust gas sent from an engine, to rotate a compressor wheel of a centrifugal compressor rotating in conjunction with the rotation of the turbine rotor to compress the intake air, and to supply the compressed air to the engine.

The above-described compressor wheel has a back surface that is configured with a flat portion extending along a radial direction of the compressor wheel and of which at least a part is in contact with another member such as a sleeve, and an outer side surface connecting the flat portion and an outer peripheral end of the back surface. In a general compressor wheel, the outer side surface has a large distance from the flat portion in the axial direction of the compressor wheel and a gentle inclination as the outer side surface goes outward in the radial direction of the compressor wheel (for example, see PTL 1).

### CITATION LIST

### Patent Literature

[PTL 1] International Publication No. WO2019/130405

### SUMMARY OF INVENTION

### Technical Problem

An airfoil shape of the compressor wheel plays an important role in compressing the intake air sent to the engine; however the airfoil shape is restricted by the stress generated in the compressor wheel during the rotation of the compressor wheel. In the back surface shape of the above-mentioned compressor wheel, there is a case where it is not possible to reduce the stress generated in the compressor wheel during the rotation of the compressor wheel to a stress range required to prevent an influence on noise generated during the rotation of the compressor wheel. In addition, in the back surface shape of the above-mentioned compressor wheel, the inertial moment of the compressor wheel tends to be large, and thus there is a concern that the transient response characteristics of the centrifugal compressor or the turbocharger including the centrifugal compressor may deteriorate.

In view of the above circumstances, an object of the at least one embodiment of the present disclosure is to provide a compressor wheel and a centrifugal compressor capable of reducing a stress generated in the compressor wheel during rotation of the compressor wheel and reducing an inertial moment of the compressor wheel.

### Solution to Problem

A compressor wheel according to at least one embodiment of the present disclosure includes:
a hub; and
at least one blade provided on an outer surface of the hub,
in which a back surface of the compressor wheel includes
   a flat portion which extends along a radial direction of the compressor wheel and which is located on a back end side of the compressor wheel in an axial direction with respect to an outer peripheral end of the back surface, and
   an outer side surface which connects the flat portion and the outer peripheral end of the back surface, and
the outer side surface has an axial recessed portion recessed toward a front end side in the axial direction with respect to the outer peripheral end of the back surface.

The centrifugal compressor according to at least one embodiment of the present disclosure includes the compressor wheel.

### Advantageous Effects of Invention

According to at least one embodiment of the present disclosure, there are provided a compressor wheel and a centrifugal compressor capable of reducing a stress generated in the compressor wheel during rotation of the compressor wheel and reducing an inertial moment of the compressor wheel.

### BRIEF DESCRIPTION OF DRAWINGS

FIG. 1 is a schematic cross-sectional view taken along an axis of a supercharger including a centrifugal compressor according to an embodiment.

FIG. 2 is a schematic cross-sectional view of a vicinity of a compressor wheel along an axis of a centrifugal compressor according to the embodiment.

FIG. 3 is a schematic cross-sectional view of a vicinity of a compressor wheel along an axis of a centrifugal compressor according to a comparative example.

FIG. 4 is a schematic cross-sectional view taken along an axis of the compressor wheel according to the embodiment.

FIG. 5 is a schematic cross-sectional view taken along an axis of the compressor wheel according to the embodiment.

### DESCRIPTION OF EMBODIMENTS

Hereinafter, some embodiments of the present disclosure will be described with reference to the accompanying drawings. However, sizes, materials, shapes, and relative dispositions of components described as the embodiments or illustrated in the drawings are not intended to limit the scope of the present disclosure, and are merely examples for describing the present disclosure.

### (Supercharger, Centrifugal Compressor)

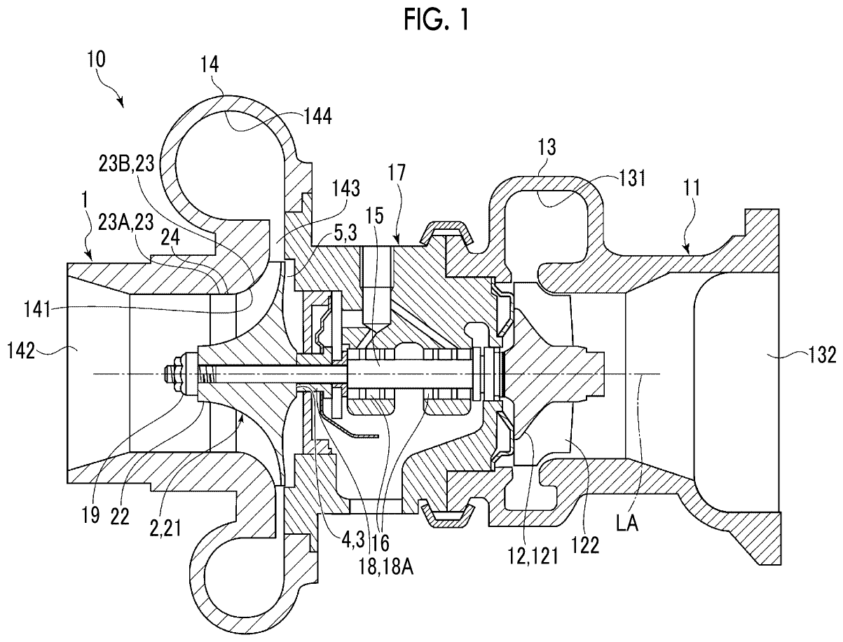

FIG. 1 is a schematic cross-sectional view taken along an axis LA of a supercharger 10 including a centrifugal compressor 1 according to an embodiment. The centrifugal compressor 1 according to the present disclosure can be mounted in, for example, a supercharger (turbocharger) 10 for an automobile, a ship, or an industry application (for example, land-based power generation). In each of the following embodiments, the centrifugal compressor 1 mounted in the supercharger (turbocharger) 10 will be described as an example, however the centrifugal compressor 1 according to the present disclosure is not limited to the centrifugal compressor mounted in the supercharger 10. In addition, the operating fluid of the centrifugal compressor 1 does not need to be limited to air. That is, the centrifugal compressor 1 of the present disclosure only needs to be able to compress the operating fluid by mechanical power (for example, rotational force), and may be configured as a single centrifugal compressor 1 or may be configured to be combined with a mechanism or a device other than the turbine 11.

As illustrated in FIG. 1, the supercharger 10 according to some embodiments is configured to be driven by energy of exhaust gas discharged from an engine (internal combustion engine, not shown) and to compress a fluid (for example, air). The supercharger 10 includes a turbine 11 that is driven by the exhaust gas discharged from the engine, and a centrifugal compressor 1 that is connected to the turbine 11 coaxially and supplies air compressed by rotation to the engine.

The turbine 11 includes a turbine rotor 12 and a turbine housing 13 configured to accommodate the turbine rotor 12 to be rotatable. The centrifugal compressor 1 includes a compressor wheel (impeller) 2 and a compressor housing 14 configured to accommodate the compressor wheel 2 to be rotatable.

As illustrated in FIG. 1, the supercharger 10 further includes a rotary shaft 15 to which the compressor wheel 2 is connected to one end side and to which the turbine rotor 12 is connected to the other end side, and a bearing 16 configured to rotatably support the rotary shaft 15 between the compressor wheel 2 and the turbine rotor 12. In addition, the supercharger 10 may further include a bearing housing 17 that is disposed between the compressor housing 14 and the turbine housing 13 and is configured to accommodate the bearing 16.

The turbine 11 is configured to rotate the turbine rotor 12 by energy of the exhaust gas discharged from the engine. Since the compressor wheel 2 is connected coaxially with the turbine rotor 12 via the rotary shaft 15, the compressor wheel 2 is rotationally driven around the axis LA in conjunction with the rotation of the turbine rotor 12. The centrifugal compressor 1 is configured to rotate and drive the compressor wheel 2 around the axis LA to intake air (air supply, gas) into the compressor housing 14, compress the air, and send the compressed air to the engine. The compressed air sent from the centrifugal compressor 1 to the engine is supplied for combustion in the engine. The exhaust gas generated by the combustion in the engine is sent from the engine to the turbine 11 to rotate the turbine rotor 12.

Hereinafter, a direction in which the axis LA of the compressor wheel 2 extends is defined as an axial direction of the compressor wheel 2 (centrifugal compressor 1), a direction orthogonal to the axis LA is defined as a radial direction of the compressor wheel 2 (centrifugal compressor 1), and a circumferential direction around the axis LA is defined as a circumferential direction of the compressor wheel 2 (centrifugal compressor 1). In the axial direction of the compressor wheel 2, a side where the outer surface 22 of the hub 21 is located with respect to the back surface 3 of the compressor wheel 2 is defined as a front end side, and a side opposite to the front end side is defined as a back end side.

### (Turbine Rotor)

The turbine rotor 12 includes a hub 121 having a substantially frustoconical shape and a plurality of turbine blades 122 provided on an outer surface of the hub 121. Since the hub 121 is connected to one end side of the rotary shaft 15, the turbine rotor 12 is provided to be rotatable integrally with the rotary shaft 15 about the axis LA. The turbine rotor 12 is configured to guide the exhaust gas introduced from the outside in the radial direction of the turbine rotor 12 to the front side of the turbine rotor 12 along the axial direction of the turbine rotor 12.

### (Turbine Housing)

In the turbine housing 13, a turbine scroll flow path 131 for guiding the exhaust gas discharged from the engine to the turbine rotor 12 and an exhaust gas discharge flow path 132 for discharging the exhaust gas passed through the turbine rotor 12 to the outside of the turbine housing 13 are formed. The turbine scroll flow path 131 is provided on an outside of the turbine rotor 12 in a radial direction and consists of a spiral flow path that extends along a circumferential direction of the turbine rotor 12. The exhaust gas discharge flow path 132 extends along the axial direction (extension direction of the axis LA) of the turbine rotor 12.

The exhaust gas discharged from the engine is guided to the turbine rotor 12 through the turbine scroll flow path 131, and the turbine rotor 12 is rotationally driven. The exhaust gas that rotationally drives the turbine rotor 12 is discharged to the outside of the turbine housing 13 through the exhaust gas discharge flow path 132.

### (Compressor Wheel)

The compressor wheel 2 includes a hub 21 having a substantially frustoconical shape and a plurality of compressor blades 23 provided on an outer surface 22 of the hub 21. Each of the plurality of compressor blades 23 protrudes from the outer surface 22 of the hub 21 and is disposed at a distance from each other in a circumferential direction around the axis LA. A gap (clearance) is formed between the tip side end (tip) 24 of the plurality of compressor blades 23 and the shroud surface 141 curved convexly so as to face the tip side end 24. That is, the compressor wheel 2 does not include an annular member covering the tip side end 24. The plurality of compressor blades 23 may include a plurality of long blades 23A and a plurality of short blades 23B that are formed to be shorter than the long blades 23A in the axial direction of the compressor wheel 2.

The compressor wheel 2 is provided to be rotatable integrally with the rotary shaft 15 about the axis LA since the hub 21 is connected to one end side of the rotary shaft 15. The compressor wheel 2 is configured to guide the air introduced along the axial direction of the compressor wheel 2 to the outside of the compressor wheel 2 in the radial direction. In the illustrated embodiment, the compressor wheel 2 is made of a metallic material (specifically, aluminum or an aluminum alloy).

### (Compressor Housing)

The compressor housing 14 has the shroud surface 141 described above. In the compressor housing 14, a gas introduction flow path 142, a diffuser flow path 143, and a scroll flow path 144 are formed.

The gas introduction flow path 142 is a flow path that intakes air (gas) from the outside of the compressor housing 14 and guides the intake air to the compressor wheel 2. The gas introduction flow path 142 is provided on one side (tip end side) of the compressor wheel 2 in the axial direction of the compressor wheel 2 and extends along the axial direction of the compressor wheel 2. By rotating and driving the compressor wheel 2, air is taken into the gas introduction flow path 142 from the outside of the compressor housing 14, and the intake air flows through the gas introduction flow path 142 and is guided to the compressor wheel 2.

The scroll flow path 144 is provided on the outside of the compressor wheel 2 in the radial direction and consists of a spiral flow path extending along the circumferential direction of the compressor wheel 2. The diffuser flow path 143 is a flow path for guiding the air passed through the compressor wheel 2 and compressed by the compressor wheel 2 to the scroll flow path 144. The diffuser flow path 143 is provided between the scroll flow path 144 and the compressor wheel 2 in the radial direction of the compressor wheel 2, and a downstream end portion (outer peripheral end portion) thereof communicates with the scroll flow path 144. The compressed air (compressed gas) compressed by the compressor wheel 2 flows into the diffuser flow path 143 and flows in the diffuser flow path 143 toward the outside in the radial direction of the compressor wheel 2 to be guided to the scroll flow path 144.

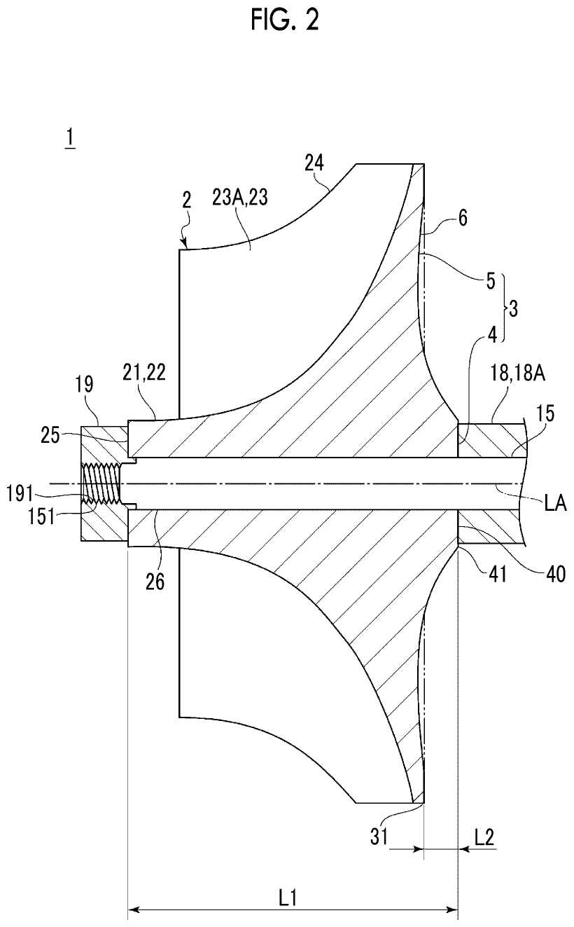

FIG. 2 is a schematic cross-sectional view of the vicinity of the compressor wheel 2 along the axis LA of the centrifugal compressor 1 according to the embodiment. As shown in FIG. 2, the compressor wheel 2 has a front end surface 25 which is an end surface on the front end side of the hub 21 in the axial direction, and a back surface 3 which is an end surface on the back end side on the hub 21 in the axial direction. The front end surface 25 extends along the radial direction of the compressor wheel 2. The back surface 3 includes a flat portion 4 that extends along the radial direction of the compressor wheel 2, and an outer side surface 5 that connects the flat portion 4 and an outer peripheral end 31 of the back surface 3. The outer side surface 5 does not have a portion that protrudes to the back end side in the axial direction with respect to the flat portion 4. The flat portion 4 includes a flat surface 40 that extends along the radial direction of the compressor wheel 2 in at least a part of the compressor wheel 2 in the circumferential direction. The flat surface 40 is not limited to a flat surface having no unevenness at all, and may have unevenness due to a tolerance or a machining accuracy during the formation of the flat surface 40. The flat portion 4 is a groove portion provided on the flat surface 40 and may include an arc-shaped or annular groove portion (not shown) extending along the circumferential direction of the compressor wheel 2. In addition, the flat portion 4 may include at least one radial groove portion (not shown) that is a groove portion provided in the flat surface 40 and extends along the radial direction of the compressor wheel 2.

In the embodiment shown in FIG. 2, in the compressor wheel 2, a through-hole 26 that extends from the front end surface 25 to the flat portion 4 along the axial direction of the compressor wheel 2 and into which the rotary shaft 15 is inserted is formed. The centrifugal compressor 1 includes a contact portion 18 that comes into contact with the flat portion 4 of the compressor wheel 2, and a locking member 19 that is locked to the rotary shaft 15 on the front end side of the compressor wheel 2 and interposes the compressor wheel 2 between the contact portion 18 and the locking member 19.

The contact portion 18 is a part of a member other than the compressor wheel 2, protrudes to an outside in a radial direction with respect to the through-hole 26, and comes into contact with at least a part of the flat portion 4. In the illustrated embodiment, the centrifugal compressor 1 includes a tubular sleeve 18A into which the rotary shaft 15 is inserted, and the contact portion 18 includes an end surface of the sleeve 18A on the front end side that comes into contact with at least a part of the flat portion 4. The sleeve 18A is prevented from moving to the back end side in the axial direction of the compressor wheel 2 by the other members such as the rotary shaft 15. The contact portion 18 may be a part of the rotary shaft 15.

In the embodiment shown in FIG. 2, the locking member 19 includes an annular nut member having a screw portion 191 formed on the inner surface, the screw portion 191 being screwed into a screw portion 151 formed on the outer surface of the rotary shaft 15 on the front end side of the compressor wheel 2. In a state where the contact portion 18 is in contact with the flat portion 4, by the screw portion 191 being screwed into the screw portion 151, the compressor wheel 2 can be interposed between the contact portion 18 and the locking member 19. Accordingly, the compressor wheel 2 is connected to the rotary shaft 15.

### (Axial Recessed Portion)

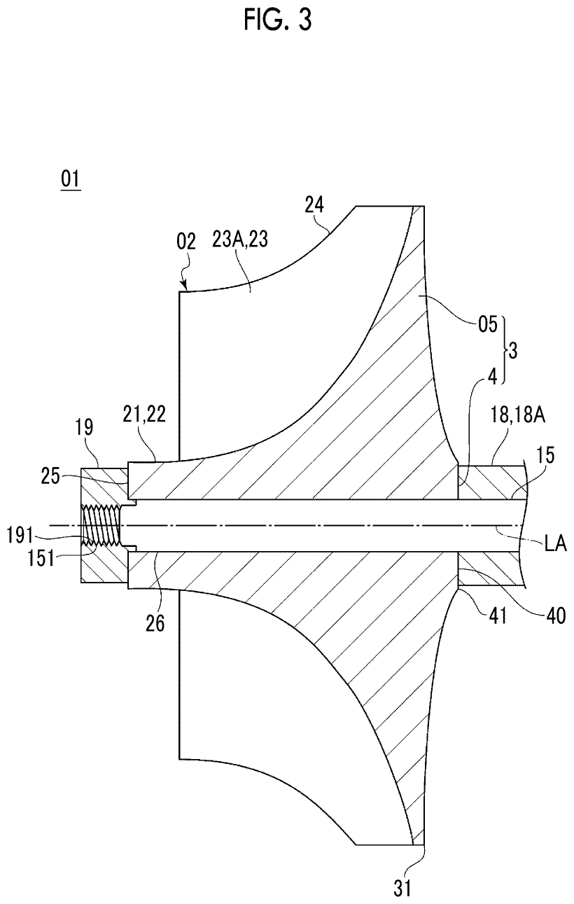

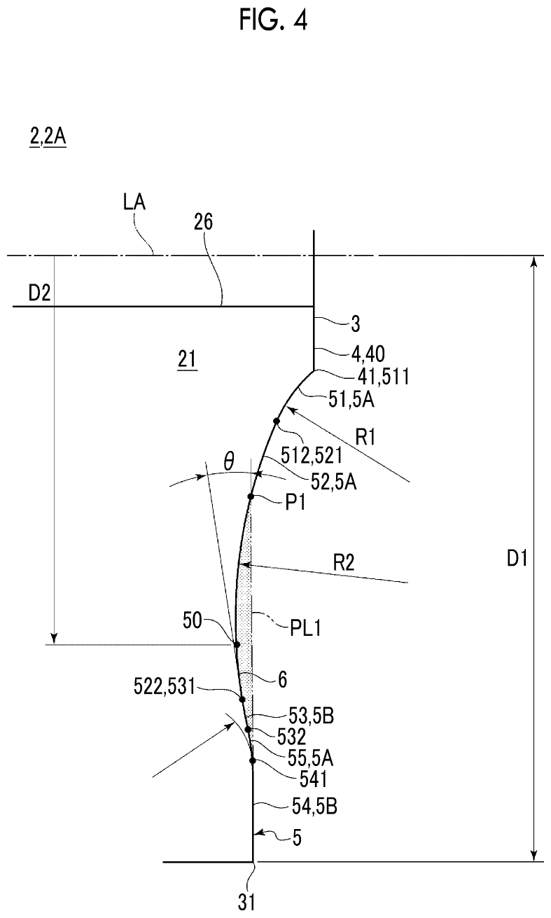

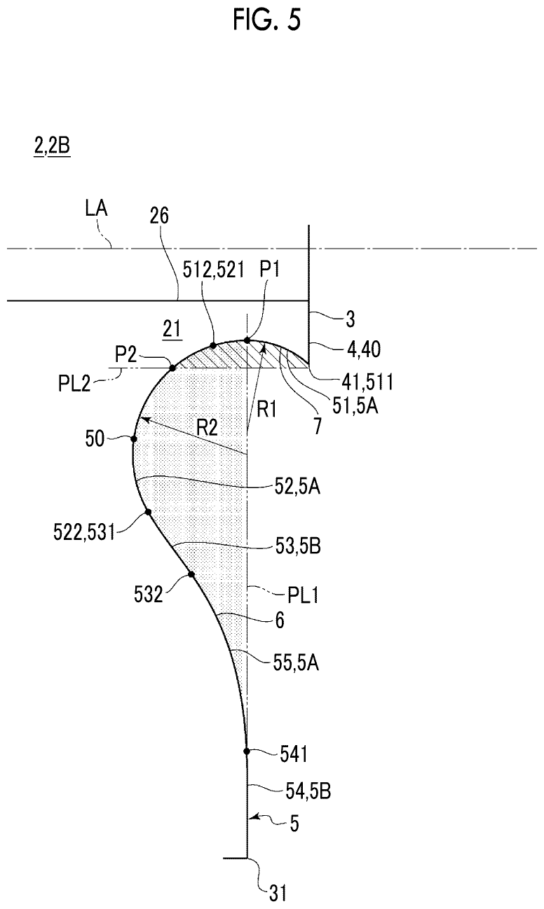

FIG. 3 is a schematic cross-sectional view of the vicinity of the compressor wheel 02 along the axis LA of the centrifugal compressor 01 according to the comparative example. FIG. 4 is a schematic cross-sectional view taken along the axis LA of the compressor wheel 2 (2A) according to the embodiment. FIG. 5 is a schematic cross-sectional view taken along the axis LA of the compressor wheel 2 (2B) according to the embodiment. As shown in FIGS. 2, 4, and 5, the compressor wheel 2 of the centrifugal compressor 1 according to some embodiments has an axial recessed portion 6 in which the outer side surface 5 is recessed toward the front end side (front end surface 25 side) of the compressor wheel 2 in the axial direction from the outer peripheral end 31 of the back surface 3. The axial recessed portion 6 means a portion of the outer side surface 5 that is located on the front end side with respect to the outer peripheral end 31 of the back surface 3 in the axial direction of the compressor wheel 2.

### (Centrifugal Compressor According to Comparative Example)

The compressor wheel 02 of the centrifugal compressor 01 according to comparative example is different from the compressor wheel 2 according to the present disclosure in that the outer side surface 05 connecting the flat portion 4 and the outer peripheral end 31 of the back surface 3 does not have the axial recessed portion 6 as shown in FIG. 3. Along the radial direction of the compressor wheel 02 toward the outside, as the distance between the outer side surface 05 and the flat portion 4 of the compressor wheel 02 in the axial direction increases, the inclination becomes moderate.

According to the above configuration, the compressor wheel 2 having the axial recessed portion 6 can reduce the mass by the region where the axial recessed portion 6 is formed as compared with the compressor wheel 02 having no axial recessed portion 6, and can reduce the centrifugal force applied to the compressor wheel 2 in the axial direction range where the axial recessed portion 6 is formed (the range between the flat portion 4 and the outer peripheral end 31 of the back surface 3 in the axial direction). Accordingly, it is possible to reduce the stress on the bore portion (in the vicinity of the through-hole 26 of the hub 21) of the compressor wheel 2 during the rotation of the compressor wheel 2. In addition, since the compressor wheel 2 having the axial recessed portion 6 has a mass reduced by a region where the axial recessed portion 6 is formed compared to the compressor wheel 02 having no axial recessed portion 6, the inertial moment (inertia) of the compressor wheel 2 is reduced. Therefore, the transient response characteristics of the centrifugal compressor 1 or the supercharger (turbocharger) 10 including the centrifugal compressor 1 are improved.

### (Shape of Outer Side Surface)

In some embodiments, as shown in FIGS. 4 and 5, the outer side surface 5 described above includes at least one arc portion 5A extending in an arc shape in a cross section along the axis LA of the compressor wheel 2 and at least one linear portion 5B extending in a linear shape in a cross section along the axis LA.

According to the above configuration, the outer side surface 5 includes at least one arc portion 5A and at least one linear portion 5B, and thus the outer side surface 5 can have a smooth shape. By making the outer side surface 5 have a smooth shape, it is possible to effectively reduce the stress on the bore portion of the compressor wheel 2 during the rotation of the compressor wheel 2.

In some embodiments, as shown in FIGS. 4 and 5, the at least one arc portion 5A described above includes at least a first arc portion 51 and a second arc portion 52. The at least one linear portion 5B described above includes at least a first linear portion 53. In other words, the outer side surface 5 described above includes at least the first arc portion 51, the second arc portion 52, and the first linear portion 53.

In the first arc portion 51, a back side end 511 is connected to the outer peripheral end 41 of the flat portion 4, and a front side end 512 is located on a front end side of the compressor wheel 2 in the axial direction with respect to the back side end 511. In the second arc portion 52, an inner peripheral end 521 is connected to the front side end 512 of the first arc portion 51, and extends from the inner peripheral end 521 to the outside in the radial direction. In the first linear portion 53, an inner peripheral end 531 is connected to an outer peripheral end 522 of the second arc portion 52, and the first linear portion 53 extends in a linear shape to the outside in the radial direction from the inner peripheral end 531.

In the embodiment shown in FIG. 4, the first arc portion 51 has a recessed shape toward the front end side in the axial direction of the compressor wheel 2, and the distance from the axis LA of the compressor wheel 2 in the radial direction increases toward the front end side in the axial direction of the compressor wheel 2. The front side end 512 is located on the outside of the back side end 511 in the radial direction of the compressor wheel 2.

In the embodiment shown in FIG. 5, the first arc portion 51 has a recessed shape toward the inside in the radial direction of the compressor wheel 2, and a distance from the axis LA of the compressor wheel 2 in the radial direction becomes smaller along the axial direction toward the front end side of the compressor wheel 2. The front side end 512 is located on the inside of the back side end 511 in the radial direction of the compressor wheel 2.

The second arc portion 52 has a recessed shape toward the front end side of the compressor wheel 2 in the axial direction. In the embodiment shown in FIGS. 4 and 5, the outer peripheral end 522 is located on the front end side in the axial direction of the compressor wheel 2 with respect to the inner peripheral end 521.

According to the above configuration, the outer side surface 5 includes at least the first arc portion 51, the second arc portion 52, and the first linear portion 53. Therefore, the outer side surface 5 can have a smooth shape having a relatively low complexity without a discontinuous point. By making the outer side surface 5 have a smooth shape, it is possible to effectively reduce the stress on the bore portion of the compressor wheel 2 during the rotation of the compressor wheel 2. In addition, since the outer side surface 5 includes at least the first arc portion 51, the second arc portion 52, and the first linear portion 53, the back surface portion of the compressor wheel 2 on which the outer side surface 5 is formed can ensure sufficient strength. In addition, with the above configuration, since the outer side surface 5 includes the first arc portion 51, the second arc portion 52, and the first linear portion 53, it is possible to suppress the vibration characteristics of the compressor blade 23 from being changed due to the operation of the centrifugal compressor 1 or the supercharger 10 including the centrifugal compressor 1.

In the embodiment illustrated in FIGS. 4 and 5, the at least one linear portion 5B described above further includes a second linear portion 54 extending in a linear shape from the outer peripheral end 31 of the back surface 3 toward the inside in the radial direction. The second linear portion 54 extends along a direction intersecting (in the example shown in the drawing, orthogonal to) the axis LA. The at least one arc portion 5A described above further includes a third arc portion 55 connecting the outer peripheral end 532 of the first linear portion 53 and the inner peripheral end 541 of the second linear portion 54. In other words, the outer side surface 5 described above includes a first arc portion 51, a second arc portion 52, a first linear portion 53, a third arc portion 55, and a second linear portion 54 in this order from the inside in the radial direction of the compressor wheel 2. Each of the first arc portion 51, the second arc portion 52, the first linear portion 53, the third arc portion 55, and the second linear portion 54 has an annular surface extending along the circumferential direction around the axis LA.

### (Front End of Axial Recessed Portion)

In some embodiments, at least one of the first arc portion 51 or the second arc portion 52 includes a front end 50 that is located closest to the front end side of the axial direction in the axial recessed portion 6. According to the above configuration, with the front end 50 being provided in the first arc portion 51 or the second arc portion 52 having no discontinuous point, it is possible to suppress stress concentration in the vicinity of the front end 50 during the rotation of the compressor wheel 2. As a result, it is possible to effectively reduce the stress on the bore portion of the compressor wheel 2 during the rotation of the compressor wheel 2.

In the embodiment shown in FIGS. 4 and 5, the second arc portion 52 and the first linear portion 53 form at least a part of the axial recessed portion 6. As shown in FIGS. 4 and 5, a virtual plane passing through the outer peripheral end 31 of the back surface 3 and orthogonal to the axis LA is defined as PL1, and an intersection point of the first arc portion 51 or the second arc portion 52 with the virtual plane PL1 is defined as P1. The axial recessed portion 6 is formed between the intersection point P1 and the inner peripheral end 541 of the second linear portion 54 on the outer side surface 5.

In the embodiment shown in FIGS. 4 and 5, the second arc portion 52 includes the front end 50 of the axial recessed portion 6. In the second arc portion 52, in a range from the inner peripheral end 521 to the front end 50, the distance between the second arc portion 52 and the flat portion 4 in the axial direction of the compressor wheel 2 increases along the radial direction of the compressor wheel 2 toward the outside. In the second arc portion 52, in a range from the front end 50 to the outer peripheral end 522, the distance between the second arc portion 52 and the flat portion 4 in the axial direction of the compressor wheel 2 decreases along the radial direction of the compressor wheel 2 toward the outside.

### (Curvature Radius of First Arc Portion and Second Arc Portion)

In some embodiments, as shown in FIG. 4, the curvature radius R1 of the first arc portion 51 is smaller than the curvature radius R2 of the second arc portion 52. In the illustrated embodiment, in a case where a distance (radial distance) from the axis LA of the compressor wheel 2 to the outer peripheral end 31 of the back surface 3 is defined as D1, the curvature radius R1 is configured to satisfy a condition of 0.075×D1≤R1≤0.15×D1. In addition, the curvature radius R2 is configured to satisfy a condition of 0.45×D1≤R2≤0.55×D1.

According to the above configuration, by setting the curvature radius R1 of the first arc portion 51, in which the back side end 511 is connected to the flat portion 4, to be relatively small, the stress applied to the flat portion 4 during the rotation of the compressor wheel 2 can be reduced. In addition, by setting the curvature radius R2 of the second arc portion 52 connecting the first arc portion 51 and the first linear portion 53 to be relatively large, the first arc portion 51, the second arc portion 52, and the first linear portion 53 of the outer side surface 5 can be formed in a smooth shape.

### (Inclination of First Linear Portion)

In some embodiments, as shown in FIGS. 4 and 5, the first linear portion 53 described above is inclined such that the inner peripheral end 531 is located on the front end side in the axial direction with respect to the outer peripheral end 532. As shown in FIG. 4, an angle (angle of the shorter side) between the above-mentioned virtual plane PL1 and the first linear portion 53 is defined as θ. In the illustrated embodiment, the compressor wheel 2 is configured to satisfy the condition of 5°≤θ≤10°.

According to the above configuration, by making the first linear portion 53 have an inclined shape such that the inner peripheral end 531 of the first linear portion 53 is located on the front end side with respect to the outer peripheral end 532, it is easy to make the curvature radius R2 of the second arc portion 52 connected to the inner peripheral end 531 of the first linear portion 53 relatively large. Accordingly, the second arc portion 52 and the first linear portion 53 of the outer side surface 5 can be smoothly connected to each other.

### (Radial Position of Front End)

In some embodiments, as illustrated in FIG. 4, in a case where a distance (radial distance) from the axis LA of the compressor wheel 2 to the outer peripheral end 31 of the back surface 3 is defined as D1, and a distance (radial distance) from the axis LA to the front end 50 located closest to the front end side of the axial direction in the axial recessed portion 6 is defined as D2, the compressor wheel 2 is configured to satisfy a condition of D2≥0.5 D1.

According to the above configuration, the larger the distance D2 is, the larger the effect of reducing the inertial moment of the compressor wheel 2 by the axial recessed portion 6 is. By configuring the compressor wheel 2 to satisfy the condition of D2≥0.5 D1, the inertial moment of the compressor wheel 2 can be effectively reduced, and thus, the transient response characteristics of the centrifugal compressor 1 or the supercharger (turbocharger) 10 including the centrifugal compressor 1 are improved. In addition, in several other embodiments, as shown in FIG. 5, the compressor wheel 2 may not be configured to satisfy the condition of D2≥0.5 D1.

### (Axial Position of Outer Peripheral End of Back Surface)

In some embodiments, as illustrated in FIG. 2, in a case where a distance (axial distance) from an end surface (front end surface) 25 on a front end side of the compressor wheel 2 in the axial direction to the flat portion 4 is defined as L1, and a distance (axial distance) from an outer peripheral end 31 of the back surface 3 to the flat portion 4 in the axial direction of the compressor wheel 2 is defined as L2, the compressor wheel 2 is configured to satisfy a condition of L2≥0.1 L1.

According to the above configuration, the larger the distance L2 is, the smaller the stress applied to the flat portion 4 during the rotation of the compressor wheel 2 is. By configuring the compressor wheel 2 to satisfy the condition of L2≥0.1 L1, the stress on the flat portion 4 during the rotation of the compressor wheel 2 can be effectively reduced.

### (Radial Recessed Portion)

In some embodiments, as shown in FIG. 5, an outer side surface 5 of the compressor wheel 2 (2B) has a radial recessed portion 7 that is recessed inward in the radial direction of the compressor wheel 2 from an outer peripheral end 41 of the flat portion 4. The radial recessed portion 7 means a portion of the outer side surface 5 that is located on the inside with respect to the outer peripheral end 41 of the flat portion 4 in the radial direction of the compressor wheel 2.

In the embodiment shown in FIG. 5, the first arc portion 51 includes an inner end located closest to the inside in the radial direction in the radial recessed portion 7. The first arc portion 51 and the second arc portion 52 form at least a part of the radial recessed portion 7. A virtual plane extending parallel to the axis LA and passing through the outer peripheral end 41 of the flat portion 4 is defined as PL2, and an intersection point of the second arc portion 52 with the virtual plane PL2 is defined as P2. The radial recessed portion 7 is formed between the intersection point P2 on the outer side surface 5 and the outer peripheral end 41 of the flat portion 4. Both the axial recessed portion 6 and the radial recessed portion 7 are formed between the intersection point P1 and the intersection point P2 on the outer side surface 5.

According to the above configuration, the compressor wheel 2B having the radial recessed portion 7 can reduce the mass by the region where the radial recessed portion 7 is formed as compared with the compressor wheel 2A not having the radial recessed portion 7, and can reduce the centrifugal force of the compressor wheel 2B in the range of axial direction in which the radial recessed portion 7 is formed. Accordingly, it is possible to reduce the stress on the bore portion (in the vicinity of the through-hole 26 of the hub 21) of the compressor wheel 2B during the rotation of the compressor wheel 2B.

As illustrated in FIG. 1, the centrifugal compressor 1 according to some embodiments includes the above-mentioned compressor wheel 2. In this case, by providing the axial recessed portion 6 and the radial recessed portion 7 in the compressor wheel 2, the stress generated in the compressor wheel 2 during the rotation of the compressor wheel 2 can be reduced, and the inertial moment of the compressor wheel 2 can be reduced.

In the present specification, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

In addition, in the present specification, an expression representing a shape such as a quadrangular shape or a cylindrical shape does not represent only a shape such as a quadrangular shape or a cylindrical shape in a geometrically strict sense, but also a shape including an uneven portion, a chamfered portion, and the like within a range in which the same effect can be obtained.

In addition, in the present specification, expressions such as “provided with”, “including”, or “having” one component are not exclusive expressions excluding the presence of other components.

The present disclosure is not limited to the above-described embodiments, and also includes a form in which modifications are added to the above-described embodiments or a form in which the embodiments are combined with each other as appropriate.

Contents described in some of the above-described embodiments are understood as follows, for example.
1) A compressor wheel (2) according to at least one embodiment of the present disclosure includes:
   a hub (21); and
   at least one blade (compressor blade 23) provided on an outer surface (22) of the hub (21),
   in which a back surface (3) of the compressor wheel (2) includes
      a flat portion (4) which extends along a radial direction of the compressor wheel (2) and which is located on a back end side of the compressor wheel (2) in an axial direction with respect to an outer peripheral end (31) of the back surface (3), and
      an outer side surface (5) which connects the flat portion (4) and the outer peripheral end (31) of the back surface (3), and
   the outer side surface (5) has an axial recessed portion (6) recessed toward a front end side in the axial direction with respect to the outer peripheral end (31) of the back surface (3).

According to the configuration of the above 1), the compressor wheel (2) having the axial recessed portion (6) can reduce the mass by the region where the axial recessed portion (6) is formed as compared with the compressor wheel (02) not having the axial recessed portion (6), and can reduce the centrifugal force related to the compressor wheel (2) in the axial direction range where the axial recessed portion (6) is formed. As a result, it is possible to reduce the stress on the bore portion (in the vicinity of the through-hole 26 of the hub 21) of the compressor wheel (2) during the rotation of the compressor wheel (2). In addition, in the compressor wheel (2) having the axial recessed portion (6), the mass is reduced by the region where the axial recessed portion (6) is formed as compared with the compressor wheel (02) not having the axial recessed portion (6), so that the inertial moment (inertia) of the compressor wheel (2) is reduced. Therefore, the transient response characteristics of the centrifugal compressor (1) or the turbocharger (10) including the centrifugal compressor (1) are improved.
2) In some embodiments, in the compressor wheel (2) according to the 1),
   the outer side surface (5) includes
      at least one arc portion (5A) extending in an arc shape in a cross section along an axis (LA) of the compressor wheel (2), and
      at least one linear portion (5B) extending in a linear shape in a cross section along the axis (LA).

According to the configuration of the above 2), the outer side surface (5) includes at least one arc portion (5A) and at least one linear portion (5B), so that the outer side surface (5) can have a smooth shape. By making the outer side surface (5) have a smooth shape, it is possible to effectively reduce the stress on the bore portion of the compressor wheel (2) during the rotation of the compressor wheel (2).
3) In some embodiments, the compressor wheel (2) according to the 2),
   the at least one arc portion (5A) includes at least
      a first arc portion (51) of which a back side end (511) is connected to the flat portion (4) and a front side end (512) is located on the front end side with respect to the back side end (511) in the axial direction, and
      a second arc portion (52) of which an inner peripheral end (521) is connected to the front side end (512) of the first arc portion (51) and which extends outward in the radial direction from the inner peripheral end (521), and
   the at least one linear portion (5B) includes at least
      a first linear portion (53) of which an inner peripheral end (531) is connected to an outer peripheral end (522) of the second arc portion (52) and which extends in a linear shape outward in the radial direction from the inner peripheral end (531).

According to the configuration of the above 3), the outer side surface (5) includes the first arc portion (51), the second arc portion (52), and the first linear portion (53). Therefore, the outer surface (5) can have a smooth shape in which the complexity is relatively low, and the discontinuous points are not present. By making the outer side surface (5) have a smooth shape, it is possible to effectively reduce the stress on the bore portion of the compressor wheel (2) during the rotation of the compressor wheel (2). In addition, the outer side surface (5) includes the first arc portion (51), the second arc portion (52), and the first linear portion (53), so that the back surface portion of the compressor wheel (2) on which the outer side surface (5) is formed can ensure sufficient strength. In addition, with the configuration of 3) described above, the outer side surface (5) includes the first arc portion (51), the second arc portion (52), and the first linear portion (53), so that it is possible to suppress the vibration characteristics of the blade (compressor blade 23) from changing due to the operation of the centrifugal compressor (1) or the supercharger (10) including the centrifugal compressor (1).
4) In some embodiments, in the compressor wheel (2) according to the 3),
   at least one of the first arc portion (51) or the second arc portion (52) includes
      a front end (50) located closest to the front end side in the axial direction in the axial recessed portion (6).

According to the configuration of the above 4), since the front end (50) is provided in the first arc portion (51) or the second arc portion (52) having no discontinuous point, it is possible to suppress stress concentration in the front end (50) during the rotation of the compressor wheel (2). As a result, it is possible to effectively reduce the stress on the bore portion of the compressor wheel (2) during the rotation of the compressor wheel (2).
5) In some embodiments, in the compressor wheel (2) according to the 3) or 4),
   a curvature radius (R1) of the first arc portion (51) is smaller than a curvature radius (R2) of the second arc portion (52).

According to the configuration of the above 5), the curvature radius (R1) of the first arc portion (51) in which the back side end (511) is connected to the flat portion (4) is set to be relatively small, so that it is possible to reduce the stress on the flat portion (4) during the rotation of the compressor wheel (2). In addition, by setting the curvature radius (R2) of the second arc portion (52) connecting the first arc portion (51) and the first linear portion (53) to be relatively large, the first arc portion (51), the second arc portion (52), and the first linear portion (53) of the outer side surface (5) can be formed in a smooth shape.
6) In some embodiments, in the compressor wheel (2) according to any one of the 3) to 5),
   the first linear portion (53) is inclined such that the inner peripheral end (531) is located on the front end side in the axial direction with respect to the outer peripheral end (532).

According to the configuration of the above 6), since the first linear portion (53) is in the inclined shape such that the inner peripheral end (531) of the first linear portion (53) is located on the front end side with respect to the outer peripheral end (532), it is easy to make the curvature radius (R2) of the second arc portion (52) connected to the inner peripheral end (531) of the first linear portion (53) relatively large. Accordingly, the second arc portion (52) and the first linear portion (53) of the outer side surface (5) can be smoothly connected to each other.
7) In some embodiments, in the compressor wheel (2) according to any one of the 1) to 6),
   in a case where a distance from an axis (LA) of the compressor wheel (2) to the outer peripheral end (31) of the back surface (3) is defined as D1, and a distance from the axis (LA) to a front end (50) located closest to the front end side in the axial direction in the axial recessed portion (6) is defined as D2, the compressor wheel (2) is configured to satisfy a condition of D2≥0.5 D1.

According to the configuration of the above 7), the effect of reducing the inertial moment of the compressor wheel (2) by the axial recessed portion (6) is increased as the distance D2 is larger. By configuring the compressor wheel (2) to satisfy the condition of D2≥0.5 D1, the inertial moment of the compressor wheel (2) can be effectively reduced, and thus, the transient response characteristics of the centrifugal compressor (1) or the turbocharger (10) including the centrifugal compressor (1) are improved.
8) In some embodiments, in the compressor wheel (2) according to any one of the 1) to 7),
   in a case where a distance from an end surface (25) on the front end side to the flat portion (4) of the compressor wheel (2) in the axial direction is defined as L1, and a distance from the outer peripheral end (31) of the back surface (3) to the flat portion (4) in the axial direction is defined as L2, the compressor wheel (2) is configured to satisfy a condition of L2≥0.1 L1.

According to the configuration of the above 8), the stress applied to the flat portion (4) during the rotation of the compressor wheel (2) can be reduced as the distance L2 is larger. By configuring the compressor wheel (2) to satisfy the condition of L2≥0.1 L1, the stress on the flat portion (4) during the rotation of the compressor wheel (2) can be effectively reduced.
9) In some embodiments, in the compressor wheel (2) according to any one of the 1) to 8),
   the outer side surface (5) has a radial recessed portion (7) recessed inward in the radial direction of the compressor wheel (2) with respect to an outer peripheral end (41) of the flat portion (4).

According to the configuration of the above 9), the compressor wheel (2B) having the radial recessed portion (7) can reduce the mass by the region where the radial recessed portion (7) is formed as compared with the compressor wheel (2A) not having the radial recessed portion (7), and can reduce the centrifugal force of the compressor wheel (2B) in the axial direction range where the radial recessed portion (7) is formed. As a result, it is possible to reduce the stress on the bore portion (in the vicinity of the through-hole 26 of the hub 21) of the compressor wheel (2B) during the rotation of the compressor wheel (2B).
10) A centrifugal compressor (1) according to at least one embodiment of the present disclosure includes the compressor wheel (2) according to any one of the 1) to 9).

According to the configuration of the above 10), since the axial recessed portion (6) or the radial recessed portion (7) is provided in the compressor wheel (2), the stress generated in the compressor wheel (2) during the rotation of the compressor wheel (2) can be reduced, and the inertial moment of the compressor wheel (2) can be reduced.

### REFERENCE SIGNS LIST

1, 01: centrifugal compressor
2, 02: compressor wheel
21: hub
23: compressor blade
3: back surface
4: flat portion
5, 05: outer side surface
6: axial recessed portion
7: radial recessed portion
10: supercharger
11: turbine
12: turbine rotor
13: turbine housing
14: compressor housing
15: rotary shaft
16: bearing
17: bearing housing
18: contact portion
18A: sleeve
19: locking member
21: hub
22: outer surface
23: compressor blade
23A: long blade
23B: short blade
24: tip side end
25: front end surface
26: through-hole
31: outer peripheral end
40: flat surface
121: hub
122: turbine blade
131: scroll flow path
132: exhaust gas discharge flow path
141: shroud surface
142: gas introduction flow path
143: diffuser flow path
144: scroll flow path
LA: axis

1. A compressor wheel comprising:
a hub; and
at least one blade provided on an outer surface of the hub,
wherein a back surface of the compressor wheel includes
a flat portion which extends along a radial direction of the compressor wheel and which is located on a back end side of the compressor wheel in an axial direction with respect to an outer peripheral end of the back surface, and
an outer side surface which connects the flat portion and the outer peripheral end of the back surface, and
the outer side surface has an axial recessed portion recessed toward a front end side in the axial direction with respect to the outer peripheral end of the back surface.

2. The compressor wheel according to claim 1,
wherein the outer side surface includes
at least one arc portion extending in an arc shape in a cross section along an axis of the compressor wheel, and
at least one linear portion extending in a linear shape in a cross section along the axis.

3. The compressor wheel according to claim 2,
wherein the at least one arc portion includes at least
a first arc portion of which a back side end is connected to the flat portion and a front side end is located on the front end side with respect to the back side end in the axial direction, and
a second arc portion of which an inner peripheral end is connected to the front side end of the first arc portion and which extends outward in the radial direction from the inner peripheral end, and
the at least one linear portion includes at least
a first linear portion of which an inner peripheral end is connected to an outer peripheral end of the second arc portion and which extends in a linear shape outward in the radial direction from the inner peripheral end.

4. The compressor wheel according to claim 3,
wherein at least one of the first arc portion or the second arc portion includes
a front end located closest to the front end side in the axial direction in the axial recessed portion.

5. The compressor wheel according to claim 3,
wherein a curvature radius of the first arc portion is smaller than a curvature radius of the second arc portion.

6. The compressor wheel according to claim 3,
wherein the first linear portion is inclined such that the inner peripheral end is located on the front end side in the axial direction with respect to the outer peripheral end.

7. The compressor wheel according to claim 1,
wherein, in a case where a distance from an axis of the compressor wheel to the outer peripheral end of the back surface is defined as D1, and a distance from the axis to a front end located closest to the front end side in the axial direction in the axial recessed portion is defined as D2, the compressor wheel is configured to satisfy a condition of D2≥0.5 D1.

8. The compressor wheel according to claim 1,
wherein, in a case where a distance from an end surface on the front end side to the flat portion of the compressor wheel in the axial direction is defined as L1, and a distance from the outer peripheral end of the back surface to the flat portion in the axial direction is defined as L2, the compressor wheel is configured to satisfy a condition of L2≥0.1 L1.

9. The compressor wheel according to claim 1,
wherein the outer side surface has a radial recessed portion recessed inward in the radial direction of the compressor wheel with respect to an outer peripheral end of the flat portion.

10. A centrifugal compressor comprising the compressor wheel according to claim 1.
